(19) United States
(12) Patent Application Publication
(10) Pub. No.: US 2009/0204748 A1
(43) Pub. Date: Aug. 13, 2009

(54) MULTI-CHANNEL FLASH MEMORY SYSTEM AND ACCESS METHOD

(75) Inventors: Se-Jeong JANG, Yongin-si (KR); Moon-Wook OH, Seoul (KR); Yang-sup LEE, Gunpo-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: Samsung Electronics Co., Ltd., Suwon-si (KR)

(21) Appl. No.: 12/369,943

(22) Filed: Feb. 12, 2009

(30) Foreign Application Priority Data
Feb. 13, 2008 (KR) 10-2008-0013092

(51) Int. Cl. G06F 12/06; G06F 13/28

(52) U.S. Cl. 711/103; 711/200; 710/22; 711/E12.085; 711/E12.078

(57) ABSTRACT

Disclosed is a multi-channel flash memory system formed by flash memories having pages divided into sectors and accessed by corresponding channels. An interface device is configured to access the flash memories via the channels by a unit of at least one sector, wherein the interface device divides an address into a plurality of addresses of sector unit and controls the divided addresses so as to be jumped by a given size.

### CROSS-REFERENCE TO RELATED APPLICATIONS

This U.S. non-provisional patent application claims priority under 35 U.S.C §119 to Korean Patent Application No. 10-2008-0013092 filed on Feb. 13, 2008, the subject matter of which is hereby incorporated by reference.

### BACKGROUND

The present invention relates to a multi-channel flash memory system. More particularly, the present invention relates to a multi-channel flash memory device capable of improving data access performance.

A conventional multi-channel flash memory system may include a plurality of flash memories and a respective plurality of channels, each corresponding to one of the plurality of flash memories. An interface device controlling access (e.g., data read, write and erase operations) to the plurality of flash memories may access multiple flash memories at the same time via different channels in a manner conventionally understood in relation to Direct Memory Access (DMA) protocols and techniques. Thus, each channel may be referred to as a DMA channel, and channels may be individually identified according to an address port and a data input/output (I/O) port.

The memory array of a flash memory is typically divided into a plurality of pages with each page being further divided in a plurality of sectors. Access operations, such as write and read operations, are commonly performed on a page-by-page basis—also referred to as a page unit basis. Corresponding pages for the plurality of flash memories may be managed as a bundle referred to as a logical “super page”. For example, a collection of 0^{th} pages for each one of the plurality of flash memories may be bundled to form a 0^{th} super page.

Generally speaking, the time required to access a flash memory via a channel is identical between the plurality of flash memories and corresponding channels. Thus, the time required to access one page of a first flash memory via a corresponding first channel should be identical to the time required to access any other page via any other channel.

In a case where a page consists of eight sectors of a 512-byte unit and a flash memory system has four flash memories, the 0^{th} pages of flash memories may be managed as a super page divided into 32 sectors (0^{th} to 31^{th} sectors). For example, a first 0^{th} page of a first memory is divided into 0^{th} to 7^{th} sectors, a second 0^{th} page of a second memory is divided into 8^{th} to 15^{th} sectors, a third 0^{th} page of a third memory is divided into 16^{th} to 23^{th} sectors, and a fourth 0^{th} page of a fourth memory is divided into 24^{th} to 31^{th} sectors.

Flash memories commonly include circuitry referred to as a page buffer. The page buffer provides “write data” to flash memory cells during a write operation and also temporarily stores “read data” read from the flash memory cells. The total access time associated with a particular flash memory may be defined in terms of the access time between flash memory cells and the page buffer and the access time between the page buffer and the interface device. For example, the access time for a read operation may include a time required to read data from flash memory cells via the page buffer and a time required to transfer the read data to the interface device. The time taken to read data from flash memory cells via the page buffer will be identical with respect to each page. However, the time required to transfer the read data to the interface device is usually directly proportional to the size of the read data.

In a case where 0^{th} to 7^{th} sectors managed as a super page are accessed via one channel during a read operation, the access time may be sequentially increased from the 0^{th} sector to the 7^{th} sector. Since 0^{th} to 15^{th} sectors managed as a super page are accessed via two channels at the same time, the access time will not materially increase under the foregoing assumptions. Likewise, since 0^{th} to 23^{th} sectors or 0^{th} to 31th sectors managed as a super page are accessed via three or four channels at the same time, the access time is not materially increased. As a result, the data access time for an assumed eight-sector size will be increased in proportion to the sector size. But, the data access time for a sector size greater than the eight-sector size will be identical with the eight-sector size. Accordingly, a time reaching the maximum access time is fast when data less than eight-sector size is accessed, when data more than eight-sector size is accessed with the maximum access size. However, this access operation may suffer from the problem that all channels are not accessed uniformly. For example, in a case where accessed sectors are less than 24, at least one channel will not be used. Thus, channel assets available in the flash memory system are not efficiently utilized and overall data access speeds will be longer than necessary.

### SUMMARY OF THE INVENTION

Embodiments of the invention provide a multi-channel flash memory system and a corresponding access method capable of improving overall data access speeds and the efficiency of access operation within a memory system.

In one embodiment, the invention provides a multi-channel flash memory system comprising; a plurality of flash memories, wherein each flash memory includes a plurality of pages, and each page includes a plurality of sectors, a plurality of channels respectively corresponding to the plurality of flash memories, and an interface device configured to receive an address and access the plurality of flash memories via the plurality of channels on a unit-by-unit basis, wherein each unit includes at least one sector, wherein the interface device divides the address into a plurality of addresses of sector unit and controls the divided addresses so as to be jumped by a given size.

In another embodiment, the invention provides an access method for a multi-channel flash memory system including a plurality of flash memories each having a plurality of pages, each page having a plurality of sectors, and a plurality of channels each corresponding to the flash memories, the method comprising; dividing an address into addresses of sector unit, performing an address jumping operation by a given size with respect to each of the divided addresses of sector unit, and performing an access operation with respect to the flash memories so that data of sector unit indicated by the addresses of sector unit are accessed.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified. In the figures:

FIG. 1 is a block diagram showing a multi-channel flash memory system according to an embodiment of the invention.

FIG. 2 is a diagram conceptually describing an access operation via a jumping function according to an embodiment of the invention.

FIG. 3 is a diagram showing address mapping of sectors according to the jumping function illustrated in FIG. 2.

FIG. 4 is a diagram showing an access time according to the embodiment of the invention illustrated FIGS. 2 and 3.

FIG. 5 is a diagram for describing an access operation via a jumping function according to another embodiment of the invention.

FIG. 6 is a diagram showing address mapping of sectors according to the jumping function illustrated in FIG. 5.

FIG. 7 is a flow chart for describing an access method within a multi-channel flash memory system according to an embodiment of the invention.

FIG. 8 is a block diagram of a multi-channel flash memory system according to another embodiment of the invention.

### DESCRIPTION OF EMBODIMENTS

Preferred embodiments of the present invention will be described hereafter in some additional detail with reference to the accompanying drawings. The present invention may, however, be embodied in different forms and should not be constructed as being limited to only the illustrated embodiments. Rather, these embodiments are presented as teaching examples. Throughout the written description and drawings like reference numerals refer to like or similar elements.

FIG. (FIG.) 1 is a block diagram of a multi-channel flash memory system according to an embodiment of the invention.

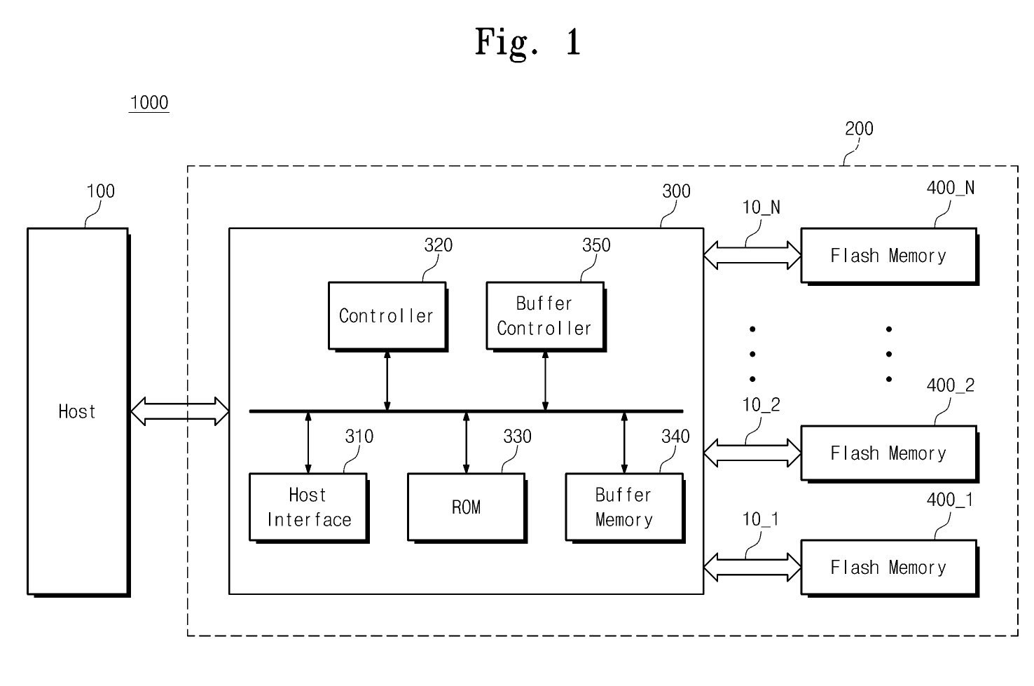

Referring to FIG. 1, a multi-channel flash memory system 1000 includes a host 100 and a storage device 200. The storage device 200 has an interface device 300, a plurality of DMA channels 10_1 to 10_N, and a plurality of nonvolatile (e.g., flash) memories 400_1 to 400_N. In its operation, the interface device 300 partitions addresses in order to access one or more of the flash memories 400_1 to 400_N. In the illustrated embodiment, sector-unit addresses (i.e., addresses of a defined sector unit) are assumed for this purpose and may be variously defined by the host 100.

That is, sector-unit addresses are addresses indicating and facilitating the access of one or more flash memories on a sector unit basis. The interface device 300 controls the definition of sector-unit addresses that further define so-called “jump addressing operations” (i.e., addressing operation conducted on a non-sequential basis). The interface device 300 controls access operations of the flash memories 400_1 to 400_N via the DMA channels 10_1 to 10_N so as to access sector-unit data indicated by corresponding jumped sector-unit addresses. Multiple flash memories 400_1 to 400_N may be accessed simultaneously (i.e., in a fully or partially overlapping manner) via respective and corresponding DMA channels 10_1 to 10_N. In the illustrated embodiment, access operations directed to the plurality flash memories 400_1 to 400_N are assumed to be made according to conventionally understood DMA techniques and protocols, for example.

The interface device 300 includes a host interface 310, a controller 320, ROM 330, a buffer memory 340, and a buffer controller 350. The host interface 310 provides an interface function between the storage device 200 and the host 100, and the controller 320 controls the overall operation of the interface device 300. For example, the controller 320 may be realized to control a program, erase, or read operation of the flash memories 400_1 to 400_N when a program, erase, or read operation is indicated by the host 100. Further, the controller 320 may perform a sector-unit access operation by assigning a particular channel. This type of access operation may be conducted using an address jumping operation (hereinafter, referred to as a jumping operation), which will be more fully described below.

The ROM 330 is generally controlled by the controller 320 and stores a memory translation layer (e.g., a Flash Translation Layer or FTL). The FTL may be used to map logical addresses generated by a file system into physical addresses associated with one or more flash memories during a write operation. This type of conventionally understood operation is a common example of ‘address mapping’.

The buffer memory 340 is controlled by the controller 320 and temporarily stores data provided from the host 100 or from the flash memories 400_1 to 400_N. Further, the FTL stored in the ROM 330 may be loaded onto the buffer memory 340 under the control of the controller 320 in order to be executed. In the illustrated embodiment, the buffer memory 340 may be implemented using a SRAM, but may be otherwise implemented using a DRAM or a non-volatile memory such as a flash memory.

The buffer controller 350 controls the operation of buffer memory 340 during a jumping operation instead of the controller 320.

As is conventional, each one of the plurality of flash memories 400_1 to 400_N comprises a memory cell array logically divided into a plurality of memory blocks. Each memory block is further divided into a plurality of pages, and each page is further divided into a plurality of sectors. The size and layout of sectors, pages, and blocks within a memory array are matters of design choice. Although not shown in FIG. 1, each of the flash memories 400_1 to 400_N includes a conventionally understood page buffer circuit. During a write operation, write data is provided to a memory cell array via one or more page buffer circuits. During a read operation, read data stored in one or more page buffer circuits is transferred to the interface device 300.

A competent jumping operation may be realized in software and/or hardware. In a case where the functionality of a jumping operation is implemented in software, the software (hereinafter, referred to as jumping operation software) may be stored in the ROM 330. The jumping operation software stored in the ROM 330 may be loaded for execution in the buffer memory 340 under the control of the controller 320. However, it is possible to store the jumping operation software in a defined “hidden region” within the flash memories 400_1 to 400_N instead of the ROM 330. In this case, the jumping operation software stored in the flash memories 400_1 to 400_N may be automatically loaded to the buffer memory 340 during a device power-up routine. The jumping operation software loaded to the buffer memory 340 may be executed under the control of the controller 320. Alternately, execution of the jumping operation software may be accomplished under the control of the buffer controller 350.

If the functionality of the jumping operation is implemented in hardware, corresponding control information defining the jumping operation may be set in an internal register of the buffer controller 350. The buffer controller 350 may perform the jumping operation according to control information. Control information stored in the register may be provided to the controller 320. In this case, execution of the jumping operation may be performed under the control of the controller 320 instead of the buffer controller 350.

If execution of the jumping operation is controlled by the controller 320, an access operation within the flash memory system 1000 may be accomplished in the following exemplary manner.

During a write operation, addresses for accessing the flash memories 400_1 to 400_N via a jumping operation are divided into sector-unit addresses, where each sector-unit address corresponds to a respective one of channels 10_1 to 10_N. The divided sector-unit addresses are then mapped into addresses indicating sectors within the corresponding flash memories 400_1 to 400_N.

Sector-unit data indicated by the divided sector-unit addresses is provided to corresponding flash memories 400_1 to 400_N via the channels 10_1 to 10_N. Further, sector-unit data, which are indicated by jumped sector-unit addresses jumped by a given size from the divided sector-unit addresses, is provided to corresponding flash memories 400_1 to 400_N via the channels 10_1 to 10_N. As a result, sector-unit data, which is indicated by jumped sector-unit addresses jumped by a given size from the divided sector-unit addresses during the write operation, is provided to corresponding flash memories 400_1 to 400_N via the channels 10_1 to 10_N. The sector-unit addresses jumped by a given size may be mapped into addresses for indicating sectors of corresponding flash memories 400_1 to 400_N.

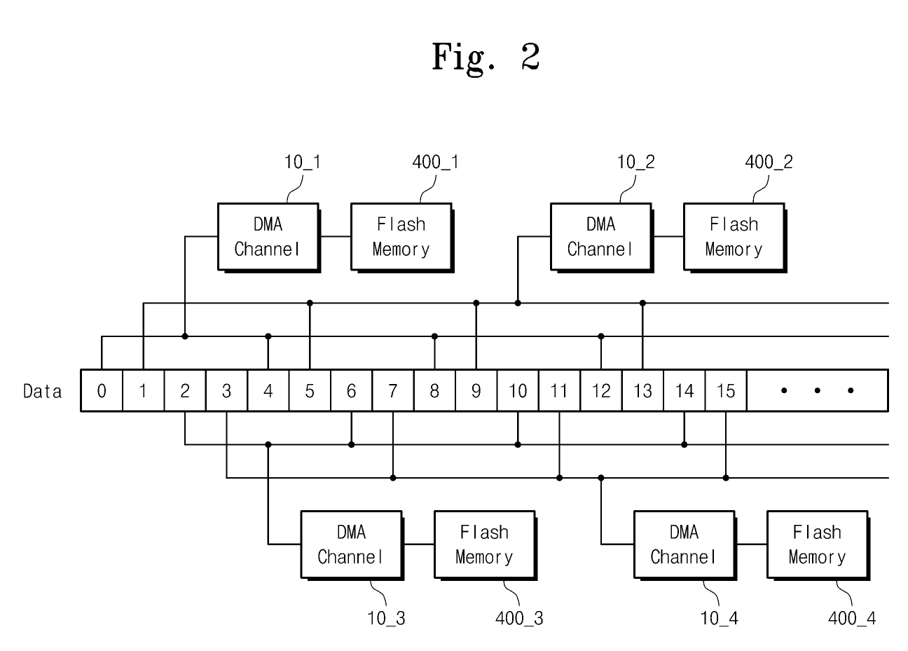

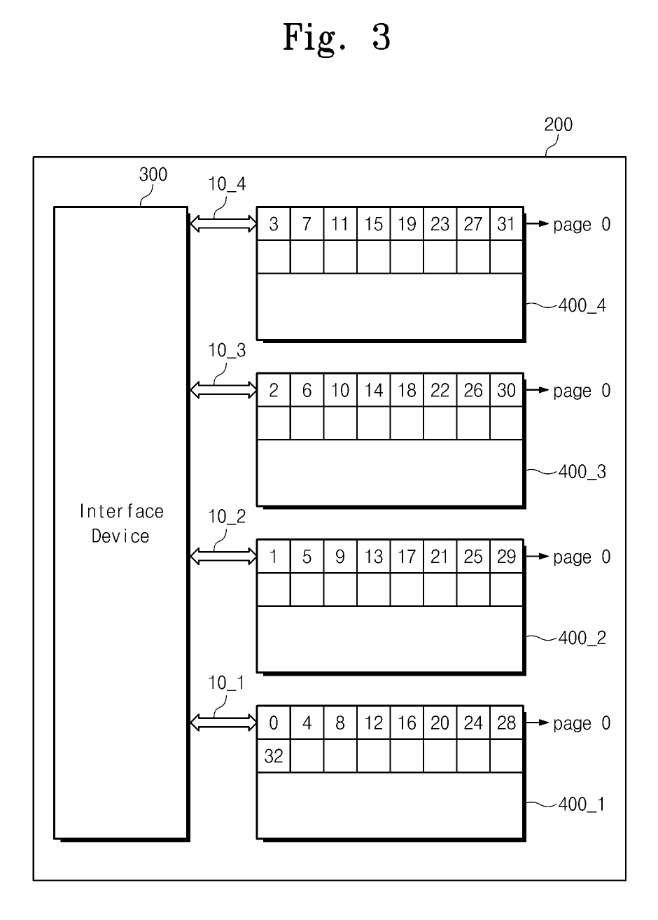

The “given size” or jumped address size may be expressed by the number of sectors corresponding to the jumped address size. The given size may be changed according to the number of flash memories to be accessed and an accessed sector unit. Sector-unit data may be data of at least one or more sector units. A given sector unit will be at least one or more sector units. An exemplary address jumping operation will be described below in some additional detail with reference to FIGS. 2 and 3. Sector data provided to flash memories 400_1 to 400_N may be stored in respective sectors of corresponding flash memories 400_1 to 400_N.

During a read operation, sector-unit data previously determined from the divided sector-unit addresses is read from the flash memories 400_1 to 400_N. Further, from the flash memories 400_1 to 400_N read is sector-unit data indicated by sector-unit addresses jumped by a given size from the divided sector-unit addresses. Accordingly, it is possible to read from the flash memories 400_1 to 400_N sector-unit data indicated by sector-unit addresses jumped by a given size from the sector-unit addresses at a read operation. The read sector-unit data may be provided into the interface device 300 via corresponding channels 10_1 to 10_N, respectively. Data provided into the interface device 300 may be temporarily stored in the buffer memory 340 before being sent to the host 100.

A jumping operation performed by the buffer controller 350 may be identical with that performed by the controller 310.

With the above-described access operation, it is possible to perform an access operation via a plurality of channels using a jumping function although a lesser amount of data is being accessed. Since an access operation is performed by efficient channel usage, overall access time is reduced. As a result, it is possible to improve access performance for a multi-channel flash memory system.

FIG. 2 is a diagram describing an access operation via a jumping function according to an embodiment of the invention. FIG. 3 is a diagram further illustrating address mapping of sectors according to the jumping function illustrated in FIG. 2.

For convenience of description, there are illustrated four flash memories 400_1 to 400_4 and four channels 10_1 to 10_4 each corresponding to the flash memories 400_1 to 400_4 in FIGS. 2 and 3. However, embodiments of the invention are not limited to this particular number and configuration of memories and channels. A write operation will first be described. Since a read operation may be performed in a similar manner according to the same sector unit as the write operation, its description may be omitted for the sake of brevity. In FIGS. 2 and 3, an access operation via a jumping operation according to an embodiment of the invention is shown with respect to one sector unit.

Referring to FIG. 2, an address for accessing flash memories 400_1 to 400_4 via the jumping operation may be divided into sector-unit addresses (e.g., 0, 1, 2, 3) each corresponding to channels 10_1 to 10_4. The divided sector-unit addresses 0, 1, 2 and 3 may be mapped into addresses indicating sectors 0, 1, 2, and 3 of corresponding flash memories 400_1 to 400_N.

Since a predetermined sector unit is 1-sector unit, sector-unit data indicated by the divided sector address 0 is provided to a sector 0 of the flash memory 400_1 via the channel 10_1. The divided sector address 0 may be an accessed sector address 0. Accordingly, provided to a sector 4 of the flash memory 400_1 via the channel 10_1 is sector data indicated by a sector address 4 that is jumped by a given size (e.g., 3-sector) from the accessed sector address 0. With this jumping operation, data indicated by one-sector addresses 0, 4, 8, and 12 are provided to corresponding sectors 0, 4, 8, and 12 of the flash memory 400_1 via the channel 10_1.

Each of pages in the flash memories 400_1 to 400_N illustrated in FIG. 3 is formed of eight sectors each being a 512-byte unit. Corresponding pages of the flash memories 400_1 to 400_N may be managed as a super page region. For example, pages 0 of the flash memories 400_1 to 400_N may be managed as a bundled 0^{th} super page. Accordingly, the 0^{th} super page is divided into 32 sectors, 0 to 31, that are address mapped as illustrated in FIG. 3.

The interface device 300 provides sector-unit data to corresponding flash memories 400_1 to 400_4 via channels 10_1 to 10_4 according to the jumping operation. For example, data indicated by addresses 0, 4, 8, 12, . . . , etc. according to the jumping operation in FIG. 2 are provided to sectors 0, 4, 8, 12, . . . , etc. via a channel 10_1. Also, data indicated by addresses 1, 5, 9, 13, . . . , etc. according to the jumping operation in FIG. 2 are provided to sectors 1, 5, 9, 13, . . . , etc. via a channel 10_2. Remaining data may be provided to flash memories 400_3 and 400_4 via channels 10_3 and 10_4 according to the above-described manner. Thus, it is possible to access a plurality of flash memories 400_1 to 400_4 in a sector unit.

Referring to FIGS. 2 and 3, as the number of flash memories to be accessed is increased, the number of sectors of a given size to be jumped also increases. For example, if the flash memory system includes eight flash memories, data of an address 0 is provided to a flash memory 400_1 via a channel 10_1, and there is jumped an address unit corresponding to seven sectors. Data of an address 8 by the jumping operation may be provided to the flash memory 400_1 via the channel 10_1. Assuming that the number of flash memories to be accessed by one-sector unit is m, the number of sectors of a given size may be (m-1).

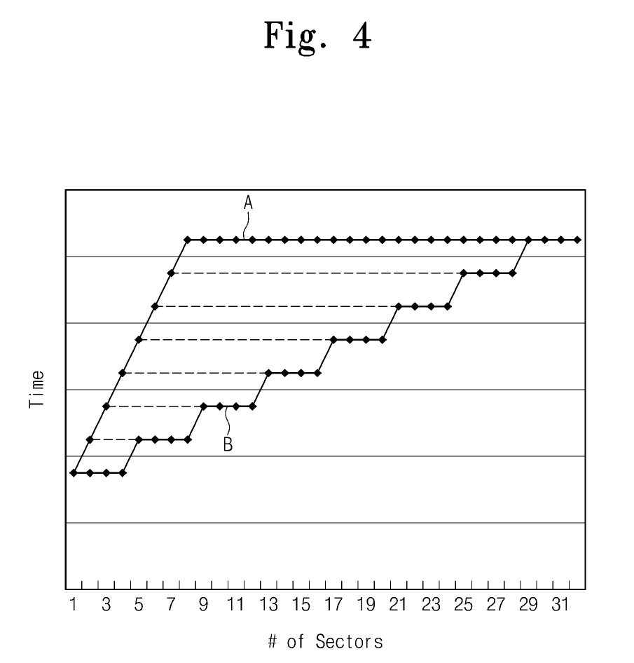

FIG. 4 is a diagram showing access time according to the embodiments of the invention illustrated FIGS. 2 and 3.

“Access time” in FIG. 4 is illustrated in relation to a write operation. However, access time in relation to read operation may have the same shape as that illustrated in FIG. 4. In a case where the above-described jumping operation is not provided, an access time for the write operation is illustrated by graph line A. In a case where the above-described jumping operation is provided, an access time of the write operation is illustrated by graph line B.

The time taken to provide data from a buffer memory 340 to a page buffer in a flash memory is proportional to the amount of data, while the time taken to store data in the page buffer to a page of the flash memory is identical with respect to respective pages.

If the jumping function is not provided, one-sector data to eight-sector data may be stored in a page of a flash memory via one channel. Accordingly, the access time for one-sector data to eight-sector data during a write operation may be increased consistent with graph line A in FIG. 4. Since sector data more than eight-sector data is accessed via a plurality of channel, its access time is identical with that of eight-sector data.

On the other hand, if the jumping function is provided, during a write operation, sector data indicated by sector addresses 0 to 3 may be provided to sectors 0 to 3 of corresponding flash memories 400_1 to 400_4 via corresponding channels 10_1 to 10_4. Since one-sector data is stored in 0^{th} pages of respective flash memories 400_1 to 400_4, respectively, the time taken to access four-sector data is identical with that to access one-sector data.

Sector data indicated by sector addresses 0 to 7 are provided to sectors 0 to 7 of corresponding flash memories 400_1 to 400_4 via channels 10_1 to 10_4. Since two-sector data are stored in 0^{th} pages of respective flash memories 400_1 to 400_4, the time taken to access eight-sector data is identical with data to access two-sector data. Thus, access time during a write operation according to the jumping function is consistent with graph line B in FIG. 4.

Referring to graph lines A and B of FIG. 4 indicating an access time, the access time B for the write operation according to the jumping function is shorter than the write operation when no jumping function is performed.

As a result, a multi-channel flash memory system according to the present invention performs an access operation via efficient channel usage, so that an access time is reduced. In other words, it is possible to improve access performance of the multi-channel flash memory system.

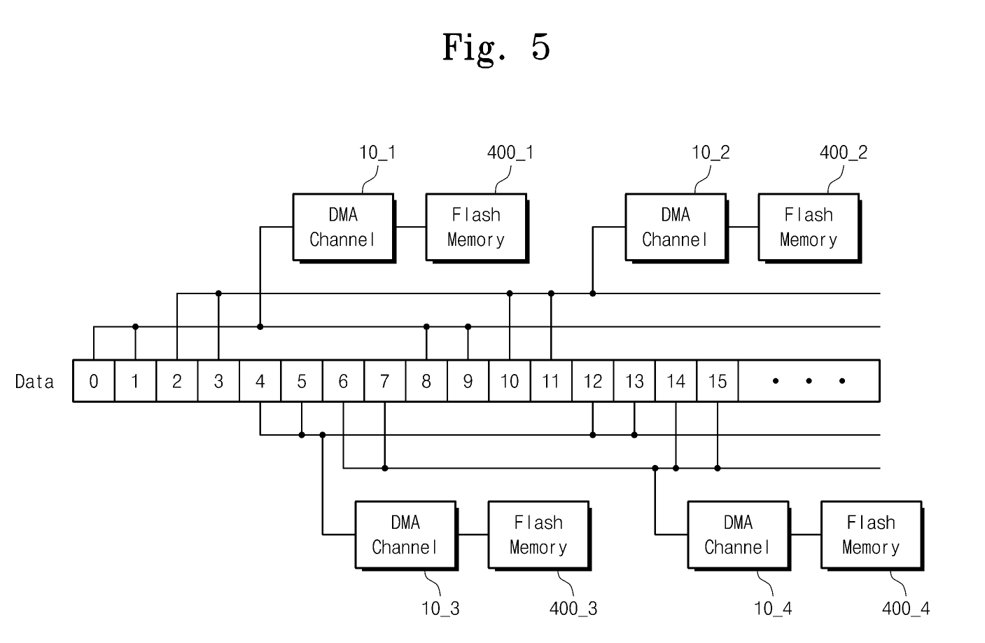

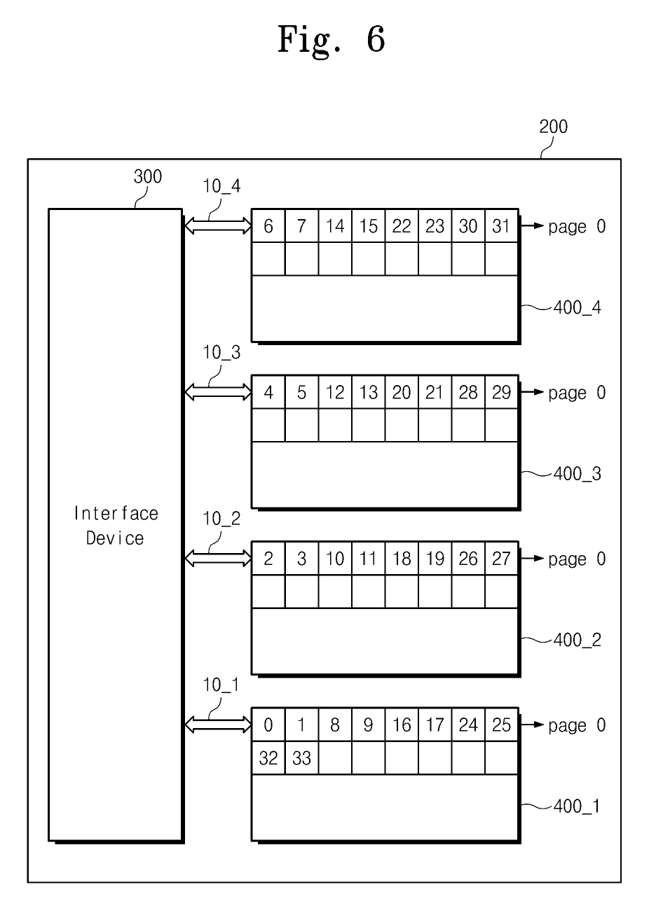

FIG. 5 is a diagram describing an access operation via a jumping function according to another embodiment of the invention. FIG. 6 is a diagram further illustrating address mapping of sectors according to the jumping function illustrated in FIG. 5.

Like FIGS. 2 and 3, for convenience of description, four flash memories 400_1 to 400_4 and four channels 10_1 to 10_4 corresponding to the flash memories 400_1 to 400_4 are illustrated in FIGS. 5 and 6. Also, a write operation will be described while description of a similarly constituted read operation is omitted. An access operation using a jumping operation according to an embodiment of the invention, as illustrated in FIGS. 5 and 6, will be described with reference to a two-sector unit access operation.

Referring to FIG. 5, an address for accessing flash memories 400_1 to 400_4 according to a jumping operation is divided into addresses of two-sector unit (0, 1), (2, 3), (4, 5) and (6, 7). The divided addresses of two-sector unit (0, 1), (2, 3), (4, 5) and (6, 7) may be mapped with addresses indicating sectors (0, 1), (2, 3), (4, 5) and (6, 7) of corresponding flash memories 400_1 to 400_N.

Since a predetermined sector unit is 2-sector unit, data of two-sector unit indicated by a divided two-sector address (0, 1) are provided to sectors (0, 1) of a flash memory 400_1 via a channel 10_1. The divided addresses (0, 1) of two-sector unit may be accessed addresses (0, 1) of two-sector unit. Accordingly, via the channel 10_1, sectors (8, 9) of the flash memory 400_1 are provided with data of two-sector unit indicated by addresses (8, 9) of two-sector unit which are jumped by six sectors (addresses 1 to 3) of a given size from the accessed addresses (0, 1) of two-sector unit. Data indicated by addresses (0, 1) and (8, 9) of two-sector unit according to the jumping operation are provided to corresponding sectors 0, 1, 8, and 9 of the flash memory 400_1 via the channel 10_1. The addresses (0, 1) and (8, 9) of two-sector unit are accessed addresses of two-sector unit.

Pages of flash memories 400_1 to 400_4 in FIG. 6 are formed of eight sectors each having 512-byte unit. A 0^{th} super page according to the illustrated embodiment is divided into 32 sectors 0 to 31 which are address mapped as illustrated in FIG. 6.

The interface device 300 supplies data of two-sector unit according to the jumping operation into corresponding flash memories 400_1 to 400_4 via channels 10_1 to 10_4. For example, via the channel 10_1, sectors (0, 1, 8, 9, . . . ) are provided with data of two-sector unit indicated by addresses (0, 1, 8, 9, . . . ) of two-sector unit according to the jumping operation illustrated in FIG. 5. Also, data of two-sector unit indicated by addresses (2, 3, 10, 11, . . . ) of two-sector unit are provided into sectors (2, 3, 10, 11, . . . ) via a channel 10_2. Remaining data of two-sector unit are provided to sectors of corresponding flash memories 400_3 and 400_4 via corresponding channels 10_3 and 10_4, as described above. Thus, it is possible to access a plurality of flash memories 400_1 to 400_4 by two-sector unit.

Referring collectively to FIGS. 2 to 6, the greater the number of unit sectors to be accessed, the greater the number of sectors corresponding to “the given size.” For example, if the number of flash memories to be accessed is 4 and an access operation is performed by one-sector unit, a sector number for the given size is 3. But, if an access operation is conducted by two-sector unit, a sector number for the given size is 6. As a result, assuming that the number of flash memories to be accessed is “m” and that a sector unit is “a”, a sector number of given size may expressed as [(m−1)*a]. That is, an address size to be jumped may be calculated by the expression [(m−1)*a], where m and a are positive integers.

Access time according to embodiments of the invention illustrated in FIGS. 5 and 6 are similar to that in FIG. 4, except that the number of sectors to be simultaneously accessed is 8.

As a result, a multi-channel flash memory system according to the illustrated embodiments of FIGS. 5 and 6 performs an access operation via efficient channel usage, such that access time may be reduced. In other words, it is possible to improve access performance of the multi-channel flash memory system.

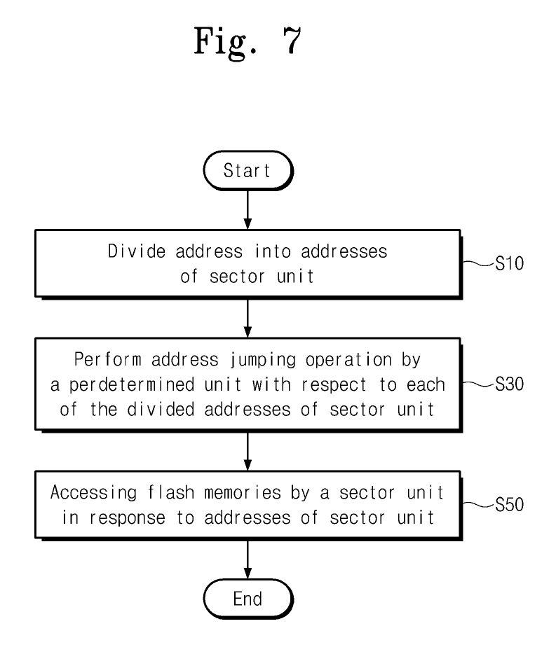

FIG. 7 is a flow chart summarizing an access method for a multi-channel flash memory system according to an embodiment of the invention.

Referring to FIG. 7, an address for accessing flash memories 400_1 to 400_N is first divided into sector-unit addresses for accessing by a sector unit (S10).

Next, address jumping may be made by a given size with respect to each of the divided sector-unit addresses (S30). As described above, the divided sector-unit addresses and the jumped sector-unit addresses may be mapped into addresses for indicating sectors of corresponding flash memories 400_1 to 400_N.

Then, the flash memories 400_1 to 400_N may be accessed via channels 10_1 to 10_N so that sector-unit data indicated by sector-unit addresses are accessed (S50).

With an access method using the jumping operation, although a lesser amount of data is identified, the access operation is performed by at least one or more sector units using a plurality of channels. Since an access operation is performed by efficient channel usage, overall access time is reduced. As a result, it is possible to improve access performance of a multi-channel flash memory system.

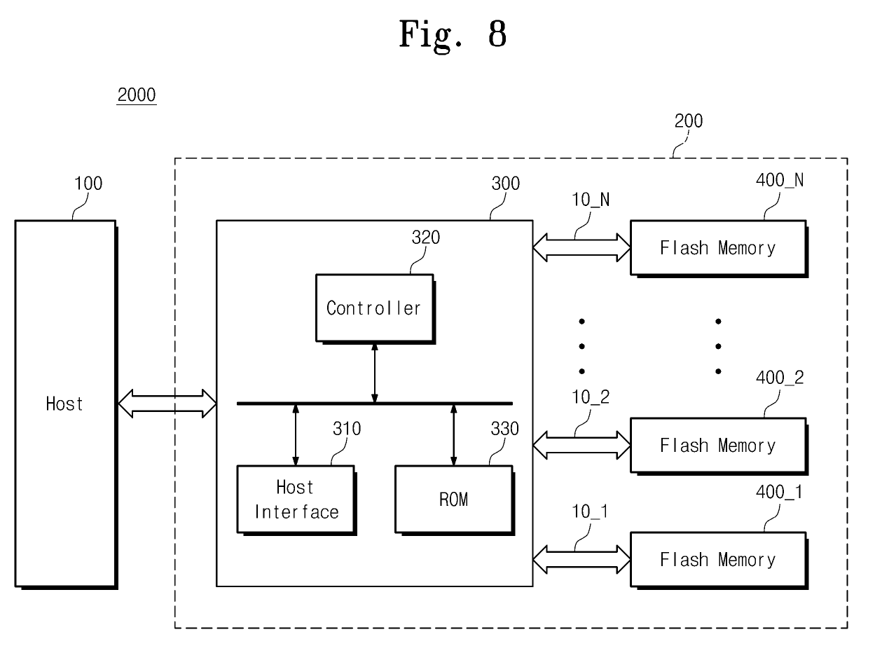

FIG. 8 is a block diagram of a multi-channel flash memory system according to another embodiment of the invention.

Multi-channel flash memory system 2000 is identical with that of system 1000 illustrated in FIG. 1 except that buffer memory 340 and buffer controller 350 are omitted. Referring to FIG. 8, data transferred from a host 100 to an interface device 300 may be provided to flash memories 400_1 to 400_N via corresponding channels 10_1 to 10_N by at least one-sector unit according to a jumping operation performed by a controller 320. The remaining operations are substantially identical with that described in FIG. 1.

But, the jumping operation is conducted in the host 100 of the multi-channel memory system 2000, and data is provided to the controller 320 via the host interface 310 by at least one or more sector units according to the jumping operation. Data of sector unit provided to the controller 320 are provided to flash memories 400_1 to 400_N via corresponding channels 10_1 to 10_N, respectively. In this case, jumping program may be provided from a storage device within the host instead of the ROM 330 and flash memories 400_1 to 400_N.

The above-disclosed subject matter is to be considered illustrative, and not restrictive, and the appended claims are intended to cover all such modifications, enhancements, and other embodiments, which fall within the scope of the invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A multi-channel flash memory system comprising:
a plurality of flash memories, wherein each flash memory includes a plurality of pages, and each page includes a plurality of sectors;
a plurality of channels respectively corresponding to the plurality of flash memories; and
an interface device configured to receive an address and access the plurality of flash memories via the plurality of channels on a unit-by-unit basis, wherein each unit includes at least one sector,
wherein the interface device divides the address into a plurality of addresses of sector unit and controls the divided addresses so as to be jumped by a given size.

2. The multi-channel flash memory system of claim 1, wherein the addresses of sector unit indicate at least one or more sectors.

3. The multi-channel flash memory system of claim 1, wherein the channels perform an access operation using a direct memory access (DMA) technique.

4. The multi-channel flash memory system of claim 1, wherein multiple ones of the plurality of flash memories are accessed simultaneously by a sector unit.

5. The multi-channel flash memory system of claim 1, wherein a jumped address size is determined according to the number of flash memories to be accessed and the sector unit to be accessed.

6. The multi-channel flash memory system of claim 5, wherein if the number of flash memories to be accessed is “m” and a sector unit is “a”, the jumped address size is defined by [(m−1)*a].

7. The multi-channel flash memory system of claim 1, wherein the interface device comprises:
a controller configured to perform the address jumping operation; and
a buffer memory configured to temporarily store write/read data,
wherein during a write operation, the controller controls the buffer memory so as to provide data of sector unit indicated by the sector-unit addresses to sectors of corresponding flash memories via the plurality of channels.

8. The multi-channel flash memory system of claim 7, wherein during a read operation, the controller controls the flash memories so as to read data of sector unit indicated by the addresses of sector unit.

9. The multi-channel flash memory system of claim 7, wherein the interface device further comprises a ROM storing jumping operation software implementing the address jumping function, wherein the controller controls execution of the jumping operation software.

10. The multi-channel flash memory system of claim 7, wherein the controller controls execution of the jumping operation software stored in a hidden region of the flash memories in order to perform the address jumping function.

11. The multi-channel flash memory system of claim 10, wherein the jumping operation software is loaded to the buffer memory upon power-up, and the loaded jumping software is executed by the controller.

12. The multi-channel flash memory system of claim 1, wherein the interface device comprises:
a buffer controller having a register storing address jumping control information; and
a buffer memory temporarily storing write/read data,
wherein the buffer controller performs an address jumping operation according to the address jumping control information; and
during a write operation, the buffer controller controls the buffer memory so as to provide data of sector unit indicated by the sector-unit addresses to sectors of corresponding flash memories via the plurality of channels.

13. The multi-channel flash memory system of claim 12, wherein during a read operation, the buffer controller controls the flash memories so as to read data of sector unit indicated by the addresses of sector unit.

14. The multi-channel flash memory system of claim 1, wherein the interface device comprises:
a buffer controller having a register storing address jumping control information;
a controller configured to perform an address jumping operation according to the address jumping control information provided from the register; and
a buffer memory temporarily storing write/read data,
wherein during a write operation, the controller controls the buffer memory so as to provide data of sector unit indicated by the addresses of sector unit to sectors of corresponding flash memories via the plurality of channels.

15. The multi-channel flash memory system of claim 14, wherein during a read operation, the controller controls the flash memories so as to read data of sector unit indicated by the addresses of sector unit.

16. An access method for a multi-channel flash memory system including a plurality of flash memories each having a plurality of pages, each page having a plurality of sectors, and a plurality of channels each corresponding to the flash memories, the method comprising:
dividing an address into addresses of sector unit;
performing an address jumping operation by a given size with respect to each of the divided addresses of sector unit; and
performing an access operation with respect to the flash memories so that data of sector unit indicated by the addresses of sector unit are accessed.

17. The access method of claim 16, wherein the addresses of sector unit indicate at least one or more sectors, and
the jumped address size corresponds to [(m−1)*a] sectors, where “m” is the number of flash memories to be accessed and “a” is a sector unit.

18. The access method of claim 16, wherein dividing the address into addresses of sector unit comprises providing data of sector unit indicated by the addresses of sector unit to sectors of corresponding flash memories via the channels.

19. The access method of claim 16, wherein the performing an access operation comprises reading data of sector unit stored in a flash memory indicated by the addresses of sector unit.
